(19) United States
(12) Patent Application Publication
(10) Pub. No.: US 2023/0256377 A1
(43) Pub. Date: Aug. 17, 2023

(54) AMINO SORBENTS FOR CAPTURING OF CO2 FROM GAS STREAMS

(71) Applicant: CLIMEWORKS AG, Zürich (CH)

(72) Inventors: Christoph GEBALD, Zürich (CH); Angelo VARGAS, Zürich (CH); Davide ALBANI, Zürich (CH); Nina-Luisa MICHELS, Zürich (CH); Visuta ENGKAGUL, Zürich (CH); Baptiste MONNEY, Zürich (CH); José Augusto BERROCAL, Zürich (CH); Christoph WEDER, Zürich (CH)

(73) Assignee: CLIMEWORKS AG, Zürich (CH)

(21) Appl. No.: 18/005,488

(22) PCT Filed: Jul. 13, 2021
(86) PCT No.: PCT/EP2021/069419

§ 371 Date: Jan. 13, 2023

(30) Foreign Application Priority Data
Jul. 16, 2020 (EP) 20186310.7

(51) Int. Cl. B01D 53/04

(52) U.S. Cl. CPC B01D 53/0462; B01D 2257/504; B01D 2253/202; B01D 2253/306; B01D 2258/06; B01D 2253/304

(57) ABSTRACT

A method for separating gaseous carbon dioxide from a gas mixture, preferably from at least one of ambient atmospheric air (1), flue gas and biogas, by cyclic adsorption/desorption using a sorbent material (3), wherein the method comprises at least the following sequential and in this sequence repeating steps (a)-(e):
(a) contacting said gas mixture (1) with the sorbent material (3) to allow gaseous carbon dioxide to adsorb;
(b) isolating said sorbent material (3) from said flow-through;
(c) inducing an increase of the temperature of the sorbent material (3);
(d) extracting at least the desorbed gaseous carbon dioxide from the unit (8) and separating gaseous carbon dioxide from steam in or downstream of the unit (8);
(e) bringing the sorbent material (3) to ambient atmospheric conditions;
   wherein said sorbent material (3) comprises primary and/or secondary amine moieties immobilized on a solid support, wherein the amine moieties, in the α-carbon position, are substituted by one hydrogen and one non-hydrogen substituent (R).

### TECHNICAL FIELD

The present invention relates to methods of carbon dioxide capture using a particular amino sorbent as well as to uses of this particular amino sorbent and to carbon dioxide capture units containing such a sorbent. Furthermore it relates to corresponding sorbent materials and methods for making same.

### PRIOR ART

According to the OECD report of 2017, the yearly emissions of CO2 to the atmosphere are ca 32.5 Gt (Gigatons, or 3×10⁹ tons).

As of February 2020 all but two of the 196 states that in 2016 have negotiated the Paris

Agreement within the United Nations Framework Convention on Climate Change (UFCCC) have ratified it. The meaning of this figure is that a consensus is reached regarding the threat of climate change and regarding the need of a global response to keep the rise of global temperature well below 2 degrees Celsius above pre-industrial levels.

The technical and scientific community engaged in the challenge of proposing solutions to meet the target of limiting CO2 emissions to the atmosphere and to remove greenhouse gases from the atmosphere has envisioned a number of technologies. Flue gas capture, or the capture of CO2 from point sources, such as specific industrial processes and specific CO2 emitters, deals with a wide range of relatively high concentrations of CO2 (3-100 vol. %) depending on the process that produces the flue gas. High concentrations makes the separation of the CO2 from other gases thermodynamically more favorable and consequently economically favorable as compared to the separation of CO2 from sources with lower concentrations, such as ambient air, where the concentration is in the order of 400 ppmv.

Nonetheless, the very concept of capturing CO2 from point sources has some strong limitations: it is specifically suitable to target such point sources, is inherently linked to specific locations where the point sources are located, and can at best limit emissions and support reaching carbon neutrality, while as a technical solution it will not be able to contribute to negative emissions (i.e., permanent removal of carbon dioxide from the atmosphere) and to remove emission from the past. In order to achieve negative emissions (i.e., permanent removal carbon dioxide from the atmosphere), the two most notable solutions currently applied, albeit being at an early stage of development, are the capturing of CO2 by means of vegetation (i.e., trees and other plants and algae) using natural photosynthesis, and by means of direct air capture (DAC) technologies.

Forestation has broad resonance with the public opinion. However, the scope and feasibility of re-forestation projects is debated and is likely to be less simple an approach as believed because it requires a large footprint in terms of occupied surface to captured CO2 ratio. On the other hand, DAC has lower land footprint and therefore it does not compete with the production of crops, and can be deployed everywhere on the planet.

The above-described strategies to mitigate climate change all have potential and are considered as a potential part of the solution. The most likely future scenario is the deployment of a mix of such approaches, after undergoing further development.

Several DAC technologies were described in expert literature, such as for example, the utilization of aqueous alkaline earth oxides to form calcium carbonate as described in US-A-2010034724. Different approaches comprise the utilization of solid CO2 adsorbents, hereafter named sorbents, in the form of monoliths or packed beds and where CO2 is captured at the gas-solid interface.

Such sorbents can contain different type of amino functionalization and polymers, such as immobilized aminosilane-based sorbents as reported in U.S. Pat. No. 8,834,822, B and amine-functionalized cellulose as disclosed in WO-A-2012/168346. WO-A-2011/049759 describes the utilization of an ion exchange material comprising an aminoalkylated bead polymer for the removal of carbon dioxide from industrial applications. WO-A-2016/037668 describes a sorbent for reversibly adsorbing CO2 from a gas mixture, where the sorbent is composed of a polymeric adsorbent having a primary amino functionality. The materials can be regenerated by applying pressure and/or humidity swing.

Several academic publications also investigated in detail the use of cross-linked polystyrene resins functionalized with primary benzyl-amines as solid sorbents for DAC and flue gas applications.

The state-of-the-art technology to capture CO2 from point sources typically uses liquid amines, as for example in industrial scrubbers, where the flue gas flows into a solution of an amine (U.S. Pat. No. 9,186,617 B). Other technologies are based on the use of solid sorbents in either a packed-bed or a flow-through structure configuration, where the sorbent is made of impregnated or covalently bound amines onto a support.

Heydari-Gorji et al. (Polyethylenimine-Impregnated Mesoporous Silica: Effect of Amine Loading and Surface Alkyl Chains on CO2 Adsorption, Langmuir 2011, 27, 12411-12416) discuss poly(ethyleneimine) (PEI) supported on pore-expanded MCM-41 whose surface is covered with a layer of long-alkyl chains, and which was found to be a more efficient CO2 adsorbent than PEI supported on the corresponding calcined silica and all PEI-impregnated materials reported in the literature. The layer of surface alkyl chains is reported to play an important role in enhancing the dispersion of PEI, thus decreasing the diffusion resistance. It was also found that at low temperature, adsorbents with relatively low PEI contents are more efficient than their highly loaded counterparts because of the increased adsorption rate. Extensive CO2 adsorption—desorption cycling showed that the use of humidified feed and purge gases affords materials with enhanced stability, despite limited loss due to amine evaporation.

Zhang et al. (Capturing CO2 from ambient air using a polyethyleneimine—silica adsorbent in fluidized beds, Chemical Engineering Science 116 (2014) 305-316) report the performance of a mesoporous silica-supported polyethyleneimine (PEI)—silica adsorbent for CO2 capture from ambient air in a laboratory-scale Bubbling Fluidized Bed (BFB) reactor. The air capture tests lasted for between 4 and 14 days using 1 kg of the PEI-silica adsorbent in the BFB reactor. Despite the low CO2 concentration in ambient air, nearly 100% CO2 capture efficiency has been achieved with a relatively short gas—solid contact time of 7.5 s. The equilibrium CO2 adsorption capacity for air capture was found to be as high as 7.3 wt %. The proposed “PEI-CFB air capture system” mainly comprises a

Circulating Fluidized Bed (CFB) adsorber and a BFB desorber with a CO2 capture capacity of 40 t-CO2/day. A large pressure drop is required to drive the air through the CFB adsorber and also to suspend and circulate the solid adsorbents within the loop, resulting in higher electricity demand than other reported air capture systems. However, the Temperature Swing Adsorption (TSA) technology adopted for the regeneration strategy in the separate BFB desorber has resulted in much smaller thermal energy requirement. The total energy required is 6.6 GJ/t-CO2 which is comparable to other reference air capture systems.

Shi et al. (Sorbents for the Direct Capture of CO2 from Ambient Air, Angew. Chem. Int. Ed. 2020, 59, 6984-7006) summarize technologies to remove CO2 from ambient air, or “direct air capture” (DAC), which have demonstrated that they can contribute to “negative carbon emission.” Advances in surface chemistry and material synthesis have resulted in new generations of CO2 sorbents, which may drive the future of DAC and its large-scale deployment. This Review describes major types of sorbents designed to capture CO2 from ambient air and they are categorized by the sorption mechanism: physisorption, chemisorption, and moisture-swing sorption.

Lee et al (Silica-Supported Sterically Hindered Amines for CO2 Capture, Langmuir 2018, 34, 41, 12279-12292) observe in extensive solution studies that sterically hindered amines can exhibit enhanced CO2 capacity when compared to their unhindered counterparts. In contrast to solution studies, there has been limited research conducted on sterically hindered amines on solid supports. In this work, one hindered primary amine and two hindered secondary amines are grafted onto mesoporous silica at similar amine coverages, and their adsorption performances are investigated through fixed bed breakthrough experiments and thermogravimetric analysis. Furthermore, chemisorbed CO2 species formed on the sorbents under dry and humid conditions are elucidated using in situ Fourier-transform infrared spectroscopy. Ammonium bicarbonate formation and enhancement of CO2 adsorption capacity is observed for all supported hindered amines under humid conditions. The experiments in this study also suggest that chemisorbed CO2 species formed on supported hindered amines are weakly bound, which may lead to reduced energy costs associated with regeneration if such materials were deployed in a practical separation process. However, overall CO2 uptake capacities of the solid supported hindered amines are modest compared to their solution counterparts.

### SUMMARY OF THE INVENTION

Amines react with CO2 to form of a carbamate moiety, which in a successive step can be regenerated to the original amine, for example by increasing the temperature of the sorbent bed to ca 100° C. and therefore releasing the CO2. An economically viable process for carbon capture implies the ability to perform the cyclic adsorption/desorption of CO2 for hundreds or thousands of cycles over the same sorbent material, where the sorbent shall not undergo any or if at all only insignificant chemical transformations that impedes its reactivity towards CO2.

Adsorption and desorption cycles of CO2 capture from a gas stream occur in the presence of varying amount of oxygen, and in particular desorption cycles involve a temperature swing, where the sorbent bed is heated to a temperature in the range of 100° C. Under such conditions amines can react with oxygen to form adducts. Examples of such adducts of linear secondary amines are depicted below:

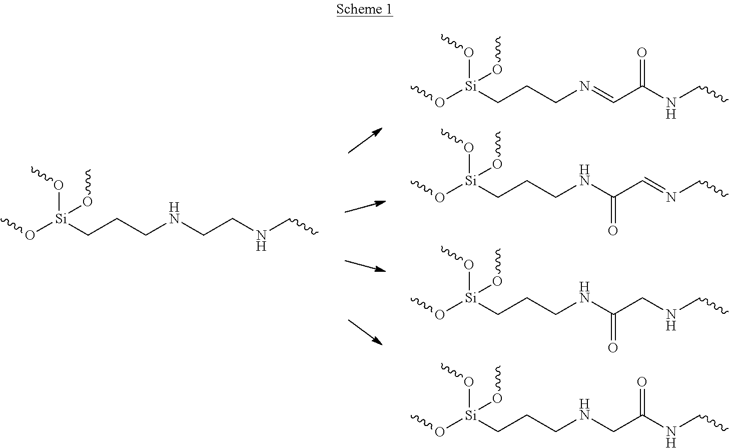

The oxidized species most likely to be found in the case of benzylamine moieties are the following:

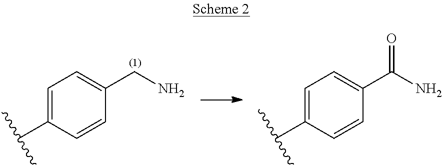 [SMILES: *c1ccc(CN)cc1 ; *c1ccc(C(N)=O)cc1]

Those major products of amine oxidative degradation, namely amide and/or imine functionalities, are suspected to be formed by a mechanism that involves as first event the hydrogen abstraction from the a carbon (definition see below). The resulting oxidized species in the form of amides and/or imines lose their ability to bind CO2.

During a carbon capture process, this is not likely to happen all at once. During multiple cycles, the oxidized species accumulate at the expense of the amines. The amines continue to react with CO2, but their number decreases with time as they are transformed into amides and/or imines or other species. This is associated with a degradation process of the CO2 capturing material because the sorbent gradually decreases its capacity to capture CO2 from the gas stream.

When this happens to such an extent that the cost of running the process does not balance the benefit of CO2 extraction, the sorbent material must be exchanged with fresh material. Before describing the invention, the notation that will be used in the following shall be defined. According to IUPAC nomenclature, the position of the carbon to which the amine is bound is indicated as C(1), or position 1. In a non-IUPAC nomenclature, but often used notation the same carbon is indicated as the alpha carbon, or α-carbon. If multiple amines groups are present on the alkyl chain the IUPAC numbering can change, since such numbering relates to the whole molecule, rather than to a single group, and will change according to the IUPAC rules of priority. In such cases the α-carbon to an amine is not necessarily the C(1). Since when there are multiple amines on an alkyl chain the numbering notation according to IUPAC allows for different numbering of the atoms to which the N is bound, for the present purpose the use of the α-carbon nomenclature is more consistent and will be used.

The term primary amines is used here to designate amines, which have one single alkyl (or aryl or alkyl-aryl) substituent bonded to the nitrogen atom, while the rest of substituents is hydrogen. The term secondary amines is used here to designate amines, which have two alkyl (or aryl) substituents bonded to the nitrogen atom, while one substituent is a hydrogen atom.

Oxidative degradation of primary and secondary amine-based solid sorbents is thought to involve hydrogen abstraction from the α-carbon to the amine functionality and to the formation of e.g. an amide. The major products of amine oxidative degradation are exemplified above. Hence, to form an amide or imine, the position of attack of the oxygen occurs at the α-carbon to the amine functionality, resulting in the loss of ability of the nitrogen atom to bind CO2 and required the α-carbon to be substituted with at least one hydrogen. The present invention relates to the use of primary or secondary amino-based sorbents, preferably polymeric sorbent substrate based, for separating gaseous carbon dioxide from a mixture in a cyclic manner, preferably from at least one of ambient air, flue gas and biogas, in particular to DAC methods, having primary amine moieties that are substituted at the α-carbon with one single substituent different from hydrogen, so having only one single hydrogen at the α-carbon and/or having secondary amine moieties that are substituted at at least one or preferably both the α-carbons with one single substituent different from hydrogen.

Such substituents can be, but are not limited to alkyl groups, such as methyl or ethyl groups. Such substitution at the α-carbon impedes the formation of the oxidation products that are observed over unsubstituted amino-based sorbents when placed in oxidative conditions that are common during the sorbent regeneration process, wherein the regeneration process can be done by increasing the temperature of the sorbent. In the case of secondary amines a di-substitution at the α-carbon also impedes the formation of imines. It must be noted that the oxidized species shown in Schemes 1 and 2 present highly conjugated α-systems that are especially stable due to electronic delocalization. The branching in the α-carbon to the amine functionality impedes the formation of double bonds as effect of the oxidation, and therefore the extensive electronic delocalization of the reaction product, thus rendering the reaction with oxygen less favorable. The utilization of the branched chains as explained above protects the molecules from the formation of products of reaction shown in Schemes 1 and 2.

In the present invention, mono-α-substituted amino-based polymeric sorbents are considered, where the sorbent can be but is not limited to a polystyrene-divinylbenzene polymer functionalized with or rather which contains α-alkylbenzylamine moieties, wherein the alkyl groups can be but are not limited to methyl or ethyl groups. Some of the styrene residues of the polystyrene can be chemically modified to become α-alkylbenzylamine moieties. The polystyrene-divinylbenzene is thus a poly(styrene-co-divinylbenzene) or styrene-divinylbenzene copolymer. More generally speaking, the polymer is a poly(styrene) or cross-linked poly(styrene), and preferably poly(styrene-co-divinylbenzene). The solid polymeric support material can be in the form of at least one of monolith (typically having a sponge-like structure for flow-through of gas mixture/ambient air), the form of a layer or a plurality of layers, the form of hollow or solid fibers, for example in woven or nonwoven (layer) structures, or the form of hollow or solid particles (beads). Preferably it takes the 5 form of preferably essentially spherical beads with a particle size (D50) in the range of 0.002-4 mm, 0.005-2 mm or 0.01-1.5 mm, preferably in the range of 0.30-1.25 mm. Possible are also particles with a particle size (D50) in the range of 0.002-1.5 mm, 0.005-1.6 mm. In another embodiment of this invention, mono-α-substituted polyethylenimine (hereinafter-named PEI) impregnated or covalently bound to a support is considered, where the support can be but is not limited to, for example, silica, alumina, carbon, silica-alumina, or zeolite. Generally speaking, the present invention relates to a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit.

The proposed method comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”);
(b) isolating said sorbent material with adsorbed carbon dioxide in said unit from said flow-through, preferably while maintaining the temperature in the sorbent;
(c) inducing an increase of the temperature of the sorbent material, preferably to a temperature between 60 and 110° C., starting the desorption of CO2 (this is e.g. possible by injecting a stream of saturated or superheated steam by flow-through through the unit and thereby inducing an increase of the temperature of the sorbent material to a temperature between 60 and 110° C., starting the desorption of CO2);
(d) extracting at least the desorbed gaseous carbon dioxide from the unit and separating gaseous carbon dioxide from steam, preferably by condensation, in or downstream of the unit;
(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.).

According one aspect of the invention, the sorbent material used in such a repeating cycle comprises primary and/or secondary amine moieties immobilized on a solid support, wherein the amine moieties, in the α-carbon position, are substituted by one hydrogen and one non-hydrogen substituent (R),In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO2 concentration in the range of 0.03-0.06% by volume. However, also air with lower or higher CO2 concentration can be used as input for the process, e.g. with a concentration of 0.1-0.5% by volume, so generally speaking, preferably the input CO2 concentration of the input gas mixture is in the range of 0.01-0.5% by volume.

Surprisingly, selectively arranging one single non-hydrogen substituent in the a position of the primary or secondary amine immensely reduces the oxidation sensitivity of the amine functionality and thereby increases the lifetime of the corresponding sorbent material in the proposed method. Previous studies on sterically hindered amines have neither considered nor demonstrated improved oxidative stability. The surprising finding is that the selective substitution on the other hand does not substantially impair the carbon dioxide capture properties, i.e. in spite of the bulky substitution in the a position the reactivity of the amine and the kinetics of carbon dioxide adsorption of the amine relative to carbon dioxide are not substantially impaired. These findings are evidenced experimentally below for the specific systems based on polystyrene (PS) or polyethyleneimine (PEI), and where the non-hydrogen substituent is a methyl group. However, the surprising effect is not limited to these examples, but is applicable also for the other embodiments according to the claimed subject matter.

The non-hydrogen substituent (R) can be selected from the group consisting of alkyl, alkenyl, arylalkyl, preferably with 1-12, particularly preferably 1-6 or 1-3 carbon atoms, —C(O)COR2, —SR2, —NR2R2, —OC(O)R2, —NR2C(O)R2, —OH, —SH, —OR2, and C(O)NR2R2, wherein each R2 is independently H or C1 to C10 (preferably C1-C5 or C1-C3) alkyl or alkenyl, preferably alkyl.

The non-hydrogen substituent (R) is preferably selected from the group of methyl or ethyl, wherein preferably the non-hydrogen substituent (R) is the same for essentially all primary and/or secondary amine moieties and is selected as methyl.

The sorbent material most preferably comprises primary α-methylbenzylamine moieties, wherein most preferably the carbon dioxide capture moieties of the sorbent material consist of primary α-methylbenzylamine moieties.

The sorbent material is typically a porous or non-porous sorbent material based on an organic and/or inorganic material, preferably a polymer material, preferably selected from the group of polystyrene, polyethylene, polypropylene, polyamide, polyurethane, acrylate based polymer including PMMA, or combinations thereof, wherein preferably the polymer material is polystyrene/polyvinyl benzene based. Also possible is cellulose, or an inorganic material including silica, alumina, activated carbon. Also combinations are possible, such as inorganic particles having an organic coating or the like.

Most preferably, the polymer material is polystyrene/polyvinyl benzene based.

The sorbent material can preferably be based on a polystyrene material throughout or preferably at least the surface exposed aromatic side chains of which are at least partially functionalized or which contain α-methylbenzylamine (1-phenylethylamine) moieties. The sorbent material can be synthesized in different ways, including through a phthalimide or a Blanc-Quelet reaction pathway or a sequence of reactions that includes at least a Friedel-Crafts acylation and a functional group interconversion involving nucleophilic, nitrogen-based reagents such as an azidation, amination, imination, or amidation step. These reactions may be carried out on either the monomer or, preferably, the polystyrene material. As mentioned above, the primary and/or secondary amine moieties can also be part of a polyethyleneimine structure, which is preferably chemically and/or physically attached to a solid support. Such a polyethyleneimine structure can be applied to and immobilized on a corresponding solid support without requiring chemical bonding.

Step (c) typically includes injecting a stream of saturated or superheated steam by flow-through through said unit. Surprisingly, the oxidation resistance is also maintained under the highly challenging conditions of high temperature air and steam.

The sorbent material, preferably in porous form, and having specific BET surface area, in the range of 0.5-100 m2/g, or 1-40 m2/g, preferably 1-20 m2/g, may take the form of a monolith, the form of a layer or a plurality of layers, the form of hollow or solid fibers, including in woven or nonwoven (layer) structures, or the form of hollow or solid particles.

The sorbent material preferably takes the form of preferably essentially spherical beads with a particle size (D50) in the range of 0.002-4 mm, 0.005-2 mm or 0.01-15 mm, preferably in the range of 0.30-1.25 mm. Possible are also particles with a particle size (D50) in the range of 0.002-1.5 mm, 0.005-1.6 mm.

Furthermore the present invention relates to a use of a sorbent material having a solid, preferably polymeric, support material functionalized on the surface with amino functionalities capable of reversibly binding carbon dioxide, for separating gaseous carbon dioxide from a gas mixture, preferably from at least one of ambient atmospheric air, flue gas and biogas, preferably for direct air capture, in particular using a temperature, vacuum, or temperature/vacuum swing process, wherein said sorbent material comprises primary and/or secondary amine moieties immobilized on a solid support, wherein the amine moieties, in the α-carbon position, are substituted by one hydrogen and one non-hydrogen substituent (R). The sorbent material for this use can have the further features as detailed above.

Said unit is preferably evacuable to a vacuum pressure of 400 mbar(abs) or less, and step (b) may include isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

Preferably, after step (d) and before step (e) the following step is carried out:
(d1) ceasing the injection and, if used, circulation of steam, and evacuation of the unit to pressure values between 20-500 mbar(abs), preferably in the range of 50-250 mbar(abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:
(b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced by way of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is preferably only effected by this steam injection and there is no additional external or internal heating e.g. by way of tubing with a heat fluid.

In step (c) furthermore preferably the sorbent can be heated to a temperature in the range of 80-110° C. or 80-100° C., preferably to a temperature in the range of 85-98° C.

According to yet another preferred embodiment, in step (c) the pressure in the unit is in the range of 700-950 mbar(abs), preferably in the range of 750-900 mbar(abs).

Also the present invention relates to a unit for separating gaseous carbon dioxide from a gas mixture, preferably from at least one of ambient atmospheric air, flue gas and biogas, preferably direct air capture unit, comprising at least one reactor unit containing sorbent material suitable and adapted for flow-through of said gas mixture,
wherein the reactor unit comprises an inlet for said gas mixture, preferably for ambient air, and an outlet for said gas mixture, preferably for ambient air during adsorption,
wherein the reactor unit is heatable to a temperature of at least 60° C. for the desorption of at least said gaseous carbon dioxide and the reactor unit being openable to flow-through of the gas mixture, preferably of the ambient atmospheric air, and for contacting it with the sorbent material for an adsorption step, wherein preferably the reactor unit is further evacuable to a vacuum pressure of 400 mbar(abs) or less,
wherein the sorbent material preferably takes the form of an adsorber structure comprising an array of individual adsorber elements, each adsorber element preferably comprising at least one support layer and at least one sorbent material layer comprising or consisting of at least one sorbent material, where said sorbent material comprises a solid, preferably polymeric support material functionalized on the surface with amino functionalities capable of reversibly binding carbon dioxide, wherein said sorbent material comprises primary and/or secondary amine moieties immobilized on a solid support, wherein the amine moieties, in the α-carbon position, are substituted by one hydrogen and one non-hydrogen substituent (R), wherein preferably the adsorber elements in the array are arranged essentially parallel to each other and spaced apart from each other forming parallel fluid passages for flow-through of said gas mixture, preferably of ambient atmospheric air and/or steam,
at least one device, preferably a condenser, for separating carbon dioxide from water, wherein preferably at the gas outlet side of said device for separating carbon dioxide from water, preferably said condenser, there is at least one of, preferably both of a carbon dioxide concentration sensor and a gas flow sensor for controlling the desorption process.

Furthermore, the present invention relates to a method for preparing a sorbent material, preferably for use in a method as detailed above.

The proposed sorbent material comprises primary and/or secondary amine moieties immobilized on a solid support.

Preferably the α-carbon position of the amine moieties in this material is substituted by one hydrogen and one non-hydrogen substituent (R), wherein the non-hydrogen substituent (R) is selected from the group consisting of alkyl, alkenyl, arylalkyl, preferably with 1-12, particularly preferably 1-6 or 1-3 carbon atoms, —C(O)COR2, —SR2, —NR2R2, —OC(O)R2, —NR2C(O)R2, —OH, —SH, —OR2, and C(O)NR2R2, wherein each R2 is independently H or C1 to C10 (preferably C1-C5 or C1-C3) alkyl or alkenyl, preferably alkyl, and wherein particularly preferably the non-hydrogen substituent (R) is selected from the group of methyl or ethyl, and wherein further preferably the non-hydrogen substituent (R) is the same for essentially all primary and/or secondary amine moieties and is selected as methyl.

The sorbent material may comprise primary α-methylbenzylamine moieties, wherein preferably the carbon dioxide capture moieties of the sorbent material consist of primary α-methylbenzylamine moieties.

According to this aspect of the invention, the sorbent material is obtained using a phthalimide or a Blanc-Quelet reaction pathway or, preferably starting from poly(styrene-co-divinylbenzene), using a sequence of reactions that includes at least a Friedel-Crafts acylation and a functional group interconversion involving nucleophilic, nitrogen-based reagents including an azidation, amination, imination, or amidation step, preferably as detailed further above.

Last but not least, the present invention relates to a sorbent material for use in a method as detailed above, preferably obtained using a method as detailed above, wherein the sorbent material comprises primary and/or secondary amine moieties immobilized on a solid support.

Again preferably the α-carbon position of the amine moieties is substituted by one hydrogen and one non-hydrogen substituent (R), wherein the non-hydrogen substituent (R) is selected from the group consisting of alkyl, alkenyl, arylalkyl, preferably with 1-12, particularly preferably 1-6 or 1-3 carbon atoms, —C(O)COR2, —SR2, —NR2R2, —OC(O)R2, —NR2C(O)R2, —OH, —SH, —OR2, and C(O)NR2R2, wherein each R2 is independently H or C1 to C10 (preferably C1-C5 or C1-C3) alkyl or alkenyl, preferably alkyl, and wherein particularly preferably the non-hydrogen substituent (R) is selected from the group of methyl or ethyl, and wherein further preferably the non-hydrogen substituent (R) is the same for essentially all primary and/or secondary amine moieties and is selected as methyl.

Preferably the sorbent material comprises primary α-methylbenzylamine moieties, wherein the carbon dioxide capture moieties of the sorbent material may consist of primary α-methylbenzylamine moieties.

Preferably, the solid support of the sorbent material is a porous or non-porous material based on an organic and/or inorganic material, preferably a polymer material, e.g. selected from the group of polystyrene, polyethylene, polypropylene, polyamide, polyurethane, acrylate based polymer including PMMA, or combinations thereof, wherein preferably the polymer material is poly(styrene) or poly(styrene-co-divinylbenzene) based, cellulose, or an inorganic material including silica, alumina, activated carbon, and combinations thereof. Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of a direct air capture unit; and

FIG. 2 shows the performance in terms of carbon dioxide capture capacity of carbon dioxide capture materials according to the invention exemplified by material obtained with alpha benzylamine, as compared with material obtained with benzylamine.

### DESCRIPTION OF PREFERRED EMBODIMENTS

Preferred embodiments of the invention are described in the following with reference to the schemes and examples, which are for illustrating the present preferred embodiments of the invention and not for limiting the same.

In some embodiments of the invention, cross-linked polystyrene beads are considered in which styrene residues are converted into α-methyl benzylamine (1-phenylethylamine) moieties. The product of degradation of such materials when used for the purpose of capturing CO2 from air streams can be a benzamide moiety, as shown in the scheme above. The process used to synthesize such material is an emulsion polymerization followed by the chloromethylation known as Blanc reaction involving formaldehyde or by phtalimide route. So possibilities to synthesize such material include, but are not limited to, a phthalimide or a Blanc-Quelet reaction pathway or a sequence of reactions that includes at least a Friedel-Crafts acylation and a functional group interconversion involving nucleophilic, nitrogen-based reagents such as an azidation, amination, imination, or amidation step. These reactions may be carried out on either the monomer or, preferably, the polystyrene material, which may, for example, be synthesized by a suspension polymerization of styrene and optionally a cross-linker, for example divinylbenzene. In one embodiment here described, the Blanc-Quelet reaction with acetaldehyde is used to obtain a cross-linked polystyrene containing α-methyl benzylamine moieties thus having in α-position to the amine a methyl group, as shown in Scheme 3 below. As the skilled person will understand, the α-substituted benzylamine moiety may have the following formula:

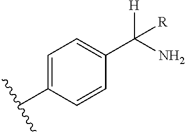

wherein R is a substituted or unsubstituted alkyl or aryl group. More preferably, R is a methyl or ethyl group.

The co-polymerization of styrene and divinylbenzene followed by the Blanc Quelet reaction with acetaldehyde to form alpha-methyl benzylamine substituted cross-linked polystyrene that does not undergo the oxidation reaction leading to the formation of benzamide substituents, as do corresponding systems as claimed, is shown in Scheme 3:

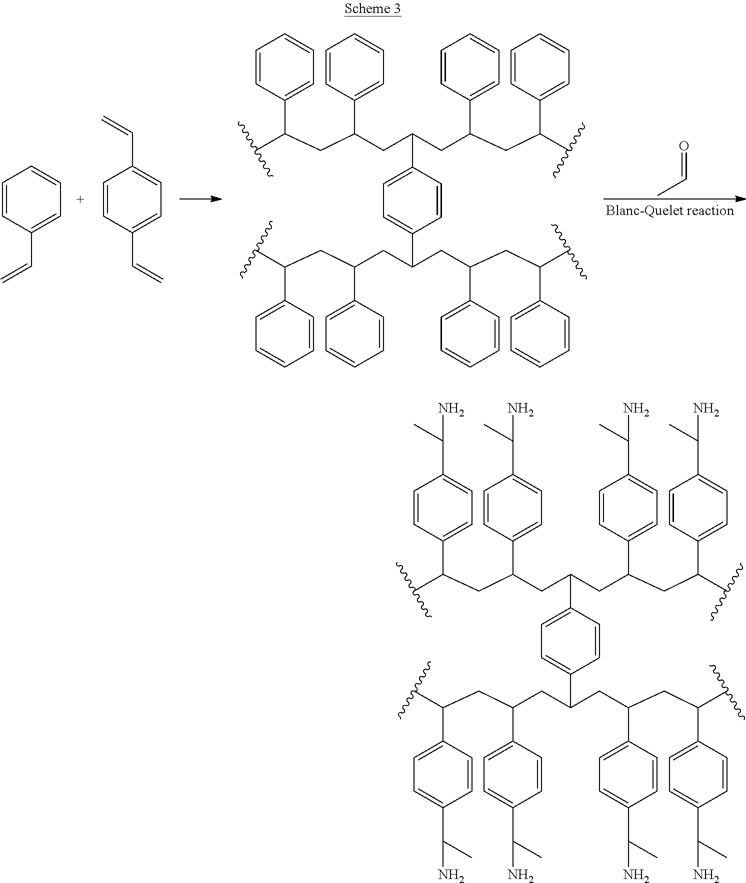

In another embodiment of the invention, a copolymerization of styrene and divinylbenzene is followed by a sequence of reactions that includes a Friedel-Crafts acylation, a reduction to alcohol, a chlorination, an azidation, and another reduction to amine, as shown in Scheme 4, wherein the specific reagents given are to be considered exemplary.

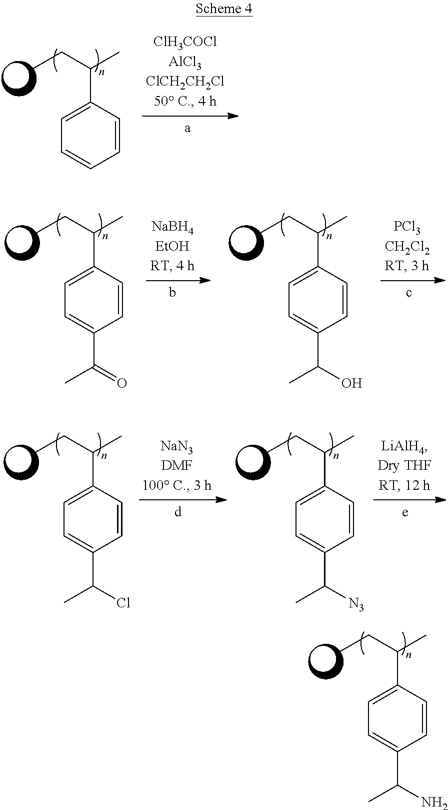

In another embodiment of the invention, polyethylenimines (PEI) are considered that can be used as active phase for carbon capture. PEI is typically synthesized by cationic polymerization of aziridine, which is initiated by electrophilic addition of an acidic catalyst to aziridine to form an aziridinium cation. An additional aziridine monomer, acting as a nucleophile, ring opens the active aziridinium ion resulting in the formation of a primary amine and a new aziridinium moiety. Subsequent aziridines attack the propagating aziridinium terminus, resulting in the linear propagation of the polymer chain. However, as the secondary amine groups in the developing polymer chain are also nucleophilic, they also ring open aziridinium species leading to branching and results in branched PEI.

Using aziridine with mono- or di-substituted α-carbons to the amine group as monomers, the final product of polymerization is constituted by branched polyamines where the alpha carbon to the amine is mono- or di-substituted with a generic R group, which can be but is not limited to, a methyl group or another alkyl, aryl or alkylaryl group. As the skilled person will understand, substructures of the α-substituted PEI may have the following formula:

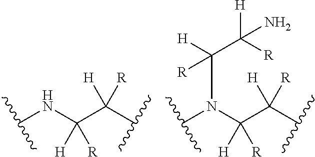

wherein R is again a substituted or unsubstituted alkyl or aryl group. More preferably, R is a methyl or ethyl group.

The polymerization is exemplified in Scheme 5 using 2,3-dimethylaziridine as monomer to form alpha-carbon methyl substituted polyethylenimine. Such branched polyamines offer improved oxidative stability as they do not undergo oxidation at the alpha carbon.

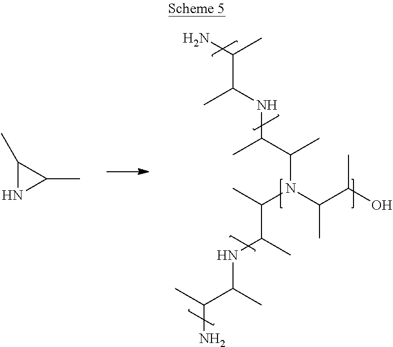

### Example 1 (PS-Alphamethylbenzylamine Sorbent Beads)

300 g of deionized water and 10 g of dispersant is added to a three-neck 1 L flask equipped with a thermometer and a reflux condenser at room temperature. To this mixture, a mixture containing 150 g of styrene, 25 g of divinylbenzene, 1.5 g of benzoyl peroxide and 90 g of pore-forming agent, which can be isooctane, toluene, wax or a mixture of thereof, is added under stirring. The temperature is increased to 70° C. for 3 h, then up to 80° C. for 4 h and completed at 95° C. for 7 h, after which the formation of the beads has occurred. The suspension is cooled down to room temperature. The poly(styrene-co-divinylbenzene) beads are filtered and are then washed three times with an equivalent volume of acetone. 100 g of poly(styrene-co-divinylbenzene) and 150 g of acetaldehyde are added to a 1 L flask. To this mixture, 3 g of zinc chloride is added and the temperature is increased to 45° C. for 16-24 h. The chloroalkylated beads are then filtered and washed three times with an equivalent volume of methyl alcohol.

To obtain the aminoalkylated polymer, the chloroalkylated beads are treated in the following way. 100 g of chloroalkylated beads and 100 g of deionized water are mixed, and then 40 g of a 200 g/L ammonia solution is added to the beads over 3 h maintaining the temperature between 3-30° C. The reaction mixture is then held for 3 h at 40° C. After cooling, 30 g of sodium hydroxide is added to the mixture. The beads are filtered and washed with water for 3 h, with acetone and finally dried.

### Example 2 (PEI Based Capture Material)

In a typical polymer synthesis, 5.0 cm³ of 1,2-dimethylaziridine are dissolved in 50 cm³ distilled water a 100-cm³ glass reaction flask. Then, 0.5 cm³ of 32 vol.% hydrochloric acid are added to the mixture, the flask is closed and immersed in an oil bath heated under reflux and under magnetic stirring. The rate of polymerization is followed monitoring change in refractive index. The solution is kept at the same temperature until the refractive index remained constant for 24 hours. Sodium hydroxide is added for neutralization. Water was removed under reduced pressure (water bath 50° C., 10 mbar) and the raw polymer was dried in vacuum for 24 h. The PEI polymer was re-dissolved in 15 ml 96% (v/v) ethanol. After filtration to remove residual sodium chloride, and rinsing flask and filter with three times 5 cm³ ethanol, the polymer was recovered by precipitation in 200 cm³ diethyl ether and dried at 50° C. in vacuum for 3 weeks.

The prepared PEI with methyl groups substituted in alpha can be either physically impregnated or chemically bound to the surface of a support. In the case of the physical impregnation, 18 g of PEI and 150 g of water are added to a round bottom flask. To this mixture, 42 g of silica is added under stirring. The flask is then connected to a rotary evaporator setting a rotation speed of 20-30 rpm. The flask is left under stirring for 3 h at room temperature, and then the temperature is increased to 50° C. and a vacuum level of ca 150 mbar is applied. After 1 h at 50° C., to completely remove the solvent, the temperature is increased to 90° C. for 2 h. The flask is left under vacuum until room temperature is reached. The sorbent is then removed from the flask and placed in a container for storage.

### Example 3 (PS-Alphamethylbenzylamine Sorbent Beads)

Step a. 20 g of poly(styrene-co-divinylbenzene) beads and 150 mL of 1,2-dichloroethane (DCE) are loaded into a reactor and stirred at RT for 5 minutes. To this suspension, 34.5 g of AlCl₃ is added. The resulting suspension is cooled to 0° C. A solution of 19.6 g acetyl chloride in 50 mL of DCE is added dropwise to the reaction mixture. When the addition is complete, the suspension is stirred at 50° C. for 4 hours. The reaction mixture is quenched with iso-propanol, and the acetylated PS beads thus made are filtered off, washed with water, 1M aqueous HCl, water again (until pH 5), and then dried.

Step b. The acetylated PS beads are dispersed in 200 mL of ethanol. To this mixture, 21.2 g of solid NaBH4 is added in portions, while the mixture is stirred at room temperature. After the addition is complete, the reaction mixture is stirred at room temperature for 4 hours. The hydroxy-functionalized PS beads thus made are filtered off, washed with water, 1M HCl, water, and are subsequently dried.

Step c. The hydroxy-functionalized PS beads are suspended in 175 mL of dichloromethane, and the suspension is cooled to 0° C. To this mixture, a solution of 57.7 g of PCIS in 175 mL of dichloromethane is added drop-wise while the reaction mixture is stirred at 0° C. The resulting suspension is then stirred at room temperature for 3 hours, after which the reaction is quenched by adding iso-propanol. The chlorine-functionalized PS beads thus made are filtered off, washed with acetone, pentane, and are subsequently dried.

Step d. The chlorine-functionalized PS beads are suspended in 250 mL of DMF and stirred for 5 minutes. 27.2 g of solid NaN₃ is added in portions while the reaction mixture is stirred at ambient temperature. The resulting suspension is then heated to 100° C. and stirred at 100° C. for 3 hours, after which it is cooled to RT. The azide-functionalized PS beads thus made are filtered off, washed with water, methanol, acetone, pentane, and are subsequently dried.

Step e. Under an inert atmosphere, 10 g of the azide-functionalized PS beads are dispersed in 80 mL of dry THF at 0° C. To this suspension, 3.3 g of solid LiAIH₄ is added in portions, while the reaction mixture was stirred at 0° C. After the addition was complete, the reaction mixture was stirred at 0° C. for one hour, and then for an additional 12 h at ambient temperature. The reaction is quenched by drop-wise addition of iso-propanol, water, and 1M aqueous NH₄Cl. Each addition is performed until no more gas evolution is observed. The suspension is then washed with a 1M aqueous HCl, and the α-methylated, amine-functionalized PS beads thus made are filtered off. The beads are washed with water (until neutral pH), methanol, acetone, pentane, and are finally dried.

### Example 4 (PS-Benzylamine Sorbent Beads)

300 g of deionized water and 10 g of dispersant is added to a three-neck 1 L flask equipped with a thermometer and a reflux condenser at room temperature. To this mixture, a mixture containing 150 g of styrene, 25 g of divinylbenzene, 1.5 g of benzoyl peroxide and 90 g of pore-forming agent, which can be isooctane, toluene, wax or a mixture of thereof, is added under stirring. The temperature is increased to 70° C. for 3 h, then up to 80° C. for 4 h and completed at 95° C. for 7 h, after which the formation of the beads has occurred. The suspension is cooled down to room temperature. The poly(styrene-co-divinylbenzene) beads are filtered and are then washed three times with an equivalent volume of acetone. To obtain the chloromethylated beads, the poly(styrene-co-divinylbenzene) beads are treated in the following way. 600 g of chloromethyl methyl ether is added to 100 g of poly(styrene-co-divinylbenzene) in a flask equipped with a thermometer and a reflux condenser. The mixture is then heated to 50° C. for 1 h, after that 60 g of ZnCl2 is added to the mixture. After 5 h of reaction, the mixture is cooled down to room temperature, the beads are separated by filtration. To quench the excess of chloromethyl methyl ether, the beads are washed with water until pH neutral, then with acetone, and dried.

To obtain the aminoalkylated beads, the chloroalkylated beads are treated in the following way. 100 g of chloroalkylated beads are added to 1000 mL of dimethoxymethane. To this suspension, 100 g of hexamethylentetramine is added. The reaction mixture is heated up to 40° C. then held at this temperature for 24 h. After cooling, the beads are filtered off and washed with water. To free the amino groups, the beads undergo a hydrolysis step followed by a treatment with sodium hydroxide. The beads are suspended in a solution containing HCl and ethanol in a 1:3 volume ratio and are left under stirring overnight. After that, the beads are separated by filtration and washed with water until pH neutral. The beads are then suspended in sodium hydroxide solution for 3 h, filtered, washed with water until pH neutral, and finally dried.

### Carbon Dioxide Capture Properties and Oxidation Resistance:

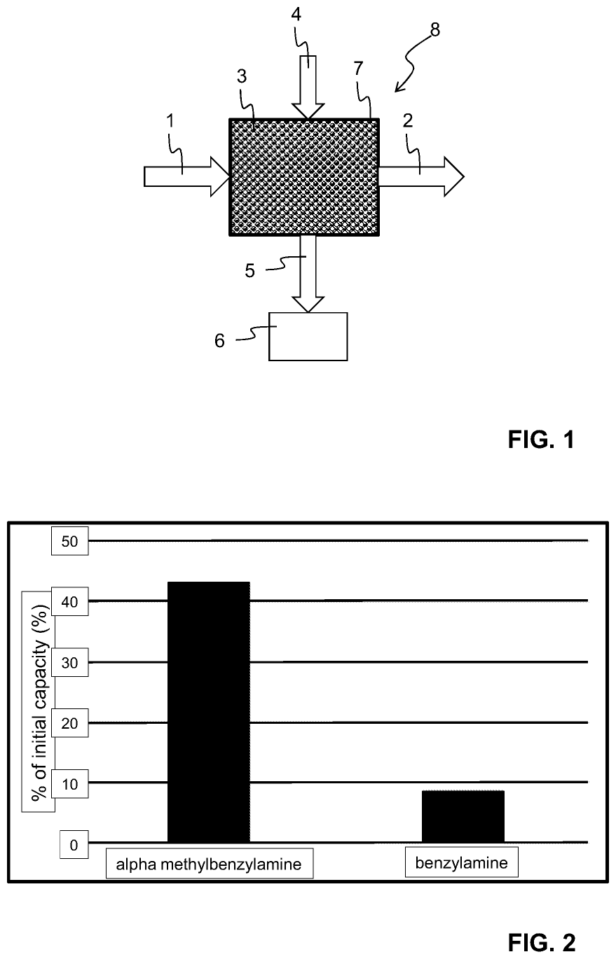

The beads according to example 3 can be tested in an experimental rig in which the beads were contained in a packed-bed reactor or in air permeable layers. The rig is schematically illustrated in FIG. 1. There is an ambient air inflow structure 1 and the actual reactor unit 8 comprises a container or wall 7 within which the layers of sorbent material 3 are located. There is an inflow structure 4 for desorption, if for example steam is used for desorption, and there is a reactor outlet 5 for extraction. Further, there is a vacuum unit 6 for evacuating the reactor.

For the adsorption measurements the results of which are illustrated further below, 6 g of dry sample was filled into a cylinder with an inner diameter of 40 mm and a height of 40 mm and placed into a CO2 adsorption/desorption device, where it was exposed to a flow of 2.0 NL/min of air at 30° C. containing 450 ppmv CO2, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO2 adsorbed on the sorbent was determined by integration of the signal of an infrared sensor measuring the CO2 content of the air stream leaving the cylinder.

The adsorber structure can alternatively be operated using a temperature/vacuum swing direct air capture process involving temperatures up to and vacuum pressures in the range of 50-250 mbar(abs) and heating the sorbent to a temperature between 60 and 110° C. In addition, experiments involving steam were carried out, with or without vacuum.

From the experiments one can see that unexpectedly the adsorption characteristics are not significantly changed due to the methyl substitution in the α-position compared with the beads having primary benzylamine according to the prior art. Some experiments even show better carbon dioxide capture properties but only so for a small number of cycle. For a high number of cycles, only the systems according to the claimed invention can maintain high carbon dioxide capture properties.

Importantly, and as an example, the methyl substituted benzylamine beads in the experiments show essentially no degradation (in the sense of decrease of adsorption characteristics over time) even if comparably high temperatures are used and/or long time spans involving high temperatures.

The experiments for this example therefore unexpectedly show that while not impairing the adsorption characteristics, the new sorbent materials, and this applies to not only this example but to the materials as claimed in the process as claimed, allow for much higher resistance to oxidative degradation and to corresponding decrease of the adsorption characteristics.

FIG. 2 illustrates, how unexpectedly the carbon dioxide capture capacity of materials according to the present invention, exemplified by carbon dioxide capture material based on benzylamine and produced according to example 4 as compared to carbon dioxide capture material based on alpha methyl benzylamine, so according to the invention, produced according to example 3 just by replacing the benzylamine by alpha methylbenzylamine.

Again, beads according to example 4 and according to this modified example 3 with alpha methylbenzylamine as starting material were tested in an experimental rig in which the beads were contained in a packed-bed reactor. The adsorber structure was operated using a temperature swing direct air capture process as detailed above heating the sorbent to a temperature between 60 and 110° C.

What is given in FIG. 2 is the results of a degradation test used to assess the stability to oxidation of the sorbents. Specifically, as an example, the alpha methyl benzylamine and the benzylamine sorbents were placed in a convection oven at 95° C. under air atmosphere for 10 days. This specific treatment is a stress test used to assess sorbent stability in a relatively short time and based on comparative experiments it is equivalent to more than 10000 adsorption/desorption cycles. After the treatment, the sorbents were tested in the rig and the carbon dioxide capture capacity was compared to the initial carbon dioxide capture capacity, i.e. before the degradation test. As one can see impressively from that representation, the oxidation of the material based on benzylamine is highly significant and leads to a dramatic reduction of the carbon dioxide capture capacity after the degradation test corresponding to an extended number of cycles compared with alpha methylbenzylamine based systems for the same number of cycles.

The same behavior is observed for materials based on PEI as compared with materials based on PEI with methyl groups substituted in alpha position.

### LIST OF REFERENCE SIGNS

| | |
|---|---|
| 1 | ambient air, ambient air |
| 2 | outflow of ambient air behind |
| | adsorption unit in adsorption |
| | flow-through mode |
| 3 | sorbent material |
| 4 | steam, steam inflow structure |
| | inflow structure |
| | for desorption |
| 5 | reactor outlet for extraction |
| 6 | vacuum unit/separator |
| 7 | wall |
| 8 | reactor unit |

1. A method for separating gaseous carbon dioxide from a gas mixture,
said gas mixture containing said gaseous carbon dioxide as well as further gases different from gaseous carbon dioxide,
by cyclic adsorption/desorption using a sorbent material adsorbing said gaseous carbon dioxide in a unit,
wherein said method comprises at least the following sequential and in this sequence repeating steps (a)-(e):
(a) contacting said gas mixture with said sorbent material to allow at least said gaseous carbon dioxide to adsorb on the sorbent material by flow-through through said unit under ambient atmospheric pressure conditions and ambient atmospheric temperature conditions in an adsorption step;
(b) isolating said sorbent material with adsorbed carbon dioxide in said unit from said flow-through;
(c) inducing an increase of the temperature of the sorbent material to a temperature starting desorption of CO2;
(d) extracting at least desorbed gaseous carbon dioxide from the unit and separating gaseous carbon dioxide from steam in or downstream of said unit;
(e) bringing the sorbent material to ambient atmospheric temperature conditions;
wherein said sorbent material comprises at least one of primary and secondary amine moieties immobilized on a solid support, wherein said amine moieties, in the α-carbon position, are substituted by one hydrogen and one non-hydrogen substituent.

2. The method according to claim 1, wherein the non-hydrogen substituent is selected from the group consisting of alkyl, alkenyl, arylalkyl, C(O)COR₂, —SR₂, —NR₂R₂, —OC(O)R₂, —NR₂C(O)R₂, —OH, —SH, —OR₂, and —C(O)NR₂R₂, wherein each R₂ is independently H or C1 to C10 alkyl or alkenyl.

3. The method according to claim 1, wherein the non-hydrogen substituent is selected from the group of methyl or ethyl.

4. The method according to claim 1, wherein the sorbent material comprises primary α-methylbenzylamine moieties.

5. The method according to claim 1, wherein the solid support of the sorbent material is a porous or non-porous material based on an organic and/or inorganic material.

6. The method according to claim 5, wherein the sorbent material is based on a polystyrene material.

7. The method according to claim 1, wherein the primary and/or secondary amine moieties are part of a polyethyleneimine structure.

8. The method according to claim 1, wherein step (c) includes injecting a stream of saturated or superheated steam by flow-through through said unit.

9. The method according to claim 1, wherein the sorbent material takes the form of a monolith, the form of a layer or a plurality of layers, the form of hollow or solid fibres, including in woven or nonwoven (layer) structures, or the form of hollow or solid particles.

10. The method according to claim 1, wherein the sorbent material takes the form of beads with a particle size (D50) in the range of 0.002-4 mm, 0.005-2 mm, 0.002-1.5 mm, 0.005-1.6 mm or 0.01-1.5 mm.

11. The method according to claim 1, wherein step (b) involves isolating said sorbent material with adsorbed carbon dioxide in said unit from said flow-through while maintaining the temperature in the sorbent.

12. The method according to claim 1, wherein step (d) involves extracting at least the desorbed gaseous carbon dioxide from the unit and separating gaseous carbon dioxide from steam by condensation in or downstream of the unit.

13. The method according to claim 1, wherein step (c) involves inducing an increase of the temperature of the sorbent material to a temperature between 60 and 110° C., starting the desorption of CO2.

14. A method of using a sorbent material having a solid support material functionalized on the surface with amino functionalities capable of reversibly binding carbon dioxide, for separating gaseous carbon dioxide from a gas mixture, wherein said sorbent material comprises at least one of primary and secondary amine moieties immobilized on a solid support, wherein the amine moieties, in the α-carbon position, are substituted by one hydrogen and one non-hydrogen substituent.

15. A unit for separating gaseous carbon dioxide from a gas mixture, comprising at least one reactor unit containing sorbent material suitable and adapted for flow-through of said gas mixture,
wherein the reactor unit comprises an inlet for said gas mixture and an outlet for said gas mixture,
wherein the reactor unit is heatable to a temperature of at least 60° C. for the desorption of at least said gaseous carbon dioxide and the reactor unit being openable to flow-through of the gas mixture, and for contacting it with the sorbent material for an adsorption step,
wherein said sorbent material comprises a solid support material functionalized on the surface with amino functionalities capable of reversibly binding carbon dioxide, wherein said sorbent material comprises primary and/or secondary amine moieties immobilized on a solid support, wherein the amine moieties, in the α-carbon position, are substituted by one hydrogen and one non-hydrogen substituent (R),
at least one device, for separating carbon dioxide from water.

16. A method for preparing a sorbent material for use in a method according to claim 1, wherein the sorbent material comprises at least one of primary and secondary amine moieties immobilized on a solid support
wherein the sorbent material is obtained using a phthalimide or a Blanc-Quelet reaction pathway or using a sequence of reactions that includes at least an acylation, including a Friedel-Crafts acylation and a functional group interconversion involving nucleophilic, nitrogen-based reagents including an azidation, amination, imination, or amidation step or a combination thereof.

17. A sorbent material for use in a method according to claim 1, wherein the sorbent material comprises at least one of primary and secondary amine moieties immobilized on a solid support,
wherein the α-carbon position of the amine moieties is substituted by one hydrogen and one non-hydrogen substituent (R), wherein the non-hydrogen substituent is selected from the group consisting of alkyl, alkenyl, arylalkyl, C(O)COR2, —SR2, —NR2R2, —OC(O)R2, —NR2C(O)R2, —OH, —SH, —OR2, and —C(O)NR2R2, wherein each R2 is independently H or C1 to C10 alkyl or alkenyl,
or wherein the sorbent material comprises primary α-methylbenzylamine moieties,
and wherein the solid support of the sorbent material is a porous or non-porous material based on an organic and/or inorganic material.

18. The method according to claim 1, wherein the gas mixture is ambient atmospheric air.

19. The method according to claim 1, wherein the non-hydrogen substituent (R) is selected from the group consisting of alkyl, alkenyl, arylalkyl, with 1-12, 1-6 or 1-3 carbon atoms, —C(O)COR₂, —SR₂, —NR₂R₂, —OC(O)R₂, —NR₂C(O)R₂, —OH, —SH, —OR₂, and —C(O)NR₂R₂, wherein each R₂ is independently H or C1-C5 or C1-C3 alkyl or alkenyl.

20. Method according to claim 1, wherein the non-hydrogen substituent (R) is the same for all primary and/or secondary amine moieties and is selected as methyl.

21. The method according to claim 1, wherein the carbon dioxide capture moieties of the sorbent material consist of primary α-methylbenzylamine moieties.

22. The method according to claim 1, wherein the solid support of the sorbent material is a porous or non-porous material organic polymer material, selected from the group of linear or branched, cross-linked or uncross-linked polystyrene, polyethylene, polypropylene, polyamide, polyurethane, acrylate based polymer including PMMA, or combinations thereof.

23. The method according to claim 1, wherein the solid support of the sorbent material is poly(styrene) or poly(styrene-co-divinylbenzene) based, cellulose, or an inorganic material including silica, alumina, activated carbon, and combinations thereof.

24. The method according to claim 5, wherein the sorbent material is based on a poly(styrene-co-divinylbenzene), which is at least partially functionalized to or contains alkylbenzylamine moieties, including α-methylbenzylamine moieties, throughout the material or at least or only on its the surface.

25. The method according to claim 24, wherein the material or the functionalization is obtained by a phthalimide or a Blanc-Quelet reaction pathway or a sequence of reactions that includes at least an acylation, including a Friedel-Crafts acylation and a functional group interconversion involving nucleophilic, nitrogen-based reagents including an azidation, amination, imination, or amidation step or a combination thereof.

26. The method according to claim 1, wherein the primary and/or secondary amine moieties are part of a polyethyleneimine structure, obtained using 2,3-dimethylaziridine, which is chemically and/or physically attached to a solid support.

27. The method according to claim 1, wherein the sorbent material, in porous form, and having specific BET surface area, in the range of 1-20 m2/g, takes the form of a monolith, the form of a layer or a plurality of layers, the form of hollow or solid fibres, including in woven or nonwoven (layer) structures, or the form of hollow or solid particles.

28. The method according to claim 1, wherein the sorbent material takes the form of essentially spherical beads with a particle size (D50) in the range of 0.30-1.25 mm.

29. The method according to claim 14, wherein it is using a temperature, vacuum, or temperature/vacuum swing process.

30. The unit according to claim 15 wherein the sorbent material takes the form of an adsorber structure comprising an array of individual adsorber elements, each adsorber element comprising at least one support layer and at least one sorbent material layer comprising or consisting of at least one sorbent material, where said sorbent material comprises a solid, polymeric support material functionalized on the surface with amino functionalities capable of reversibly binding carbon dioxide,
and/or wherein it comprises at least one a condenser, for separating carbon dioxide from water,
and/or wherein at the gas outlet side of said device for separating carbon dioxide from water, there is at least one of a carbon dioxide concentration sensor and a gas flow sensor for controlling the desorption process.

31. The method according to claim 16, wherein the α-carbon position of the amine moieties is substituted by one hydrogen and one non-hydrogen substituent (R), wherein the non-hydrogen substituent (R) is selected from the group consisting of alkyl, alkenyl, arylalkyl, with 1-12, carbon atoms, —C(O)COR2, —SR2, —NR2R2, —OC(O)R2, —NR2C(O)R2, —OH, —SH, —OR2, and —C(O)NR2R2, wherein each R2 is independently H or C1 to C10, alkyl or alkenyl,
and/or wherein the sorbent material is obtained using a phthalimide or a Blanc-Quelet reaction pathway or using a sequence of reactions that includes at least an acylation, including a Friedel-Crafts acylation and a functional group interconversion involving nucleophilic, nitrogen-based reagents including an azidation, amination, imination, or amidation step or a combination thereof, wherein poly(styrene-co-divinylbenzene) serves as a starting material.

32. The sorbent material according to claim 17, wherein the sorbent material comprises primary α-methylbenzylamine moieties,
and wherein the solid support of the sorbent material is a porous material based on an organic polymer material, selected from the group of polystyrene, polyethylene, polypropylene, polyamide, polyurethane, acrylate based polymer including PMMA, or combinations thereof, wherein including poly(styrene) or poly(styrene-co-divinylbenzene) based, cellulose, or an inorganic material including silica, alumina, activated carbon, and combinations thereof.
